(19) United States
(12) Patent Application Publication
(10) Pub. No.: US 2017/0359728 A1
(43) Pub. Date: Dec. 14, 2017

(54) UNLICENSED SPECTRUM COMMUNICATIONS RETRANSMISSION METHOD, AND BASE STATION AND USER EQUIPMENT

(71) Applicant: Sharp Kabushiki Kaisha, Osaka (JP)

(72) Inventors: QI JIANG, Shanghai (CN); RENMAO LIU, Shanghai (CN); XINGYA SHEN, Shanghai (CN)

(73) Assignee: Sharp Kabushiki Kaisha, Osaka (JP)

(21) Appl. No.: 15/521,191

(22) PCT Filed: Nov. 3, 2015
(86) PCT No.: PCT/CN2015/093657

§ 371 Date: Apr. 21, 2017

(30) Foreign Application Priority Data
Nov. 4, 2014 (CN) 201410612831.4

(51) Int. Cl. H04W 16/14; H04L 1/18

(52) U.S. Cl. CPC H04W 16/14; H04L 1/1861

(57) ABSTRACT

Disclosed are a data retransmission method used in a communications system supporting an unlicensed carrier, and a base station and user equipment executing said method. The method according to the embodiments of the present invention comprises: configuration information instructing a HARQ entity to match a plurality of serving cells is sent to the user equipment, wherein the number of serving cells matched to said HARQ entity is equal to or less than the number of serving cells the serving base station configures for the user equipment; according to said configuration of the HARQ entity matched to the plurality of serving cells, data is initially transmitted and retransmitted.

### TECHNICAL FIELD

The present invention relates to the technical field of wireless communication. More specifically, the present invention relates to a data retransmission method applied in a communication system supporting an unlicensed carrier, and a corresponding base station and user equipment.

### BACKGROUND

Modern wireless mobile communication systems present two salient features. One is broadband and high rate, for example, the fourth generation wireless mobile communication system has a bandwidth of up to 100 MHz and a downlink rate of up to 1 Gbps. The other feature is mobile internet, which advances emerging services, such as WAP, video on demand by mobile phone, and online navigation. These two features put forward higher requirements for the wireless mobile communication technology, mainly including: ultra-high-rate wireless transmission, inter-area interference suppression, reliable mobile transmission of signals, distributed/centralized signal processing and so on. In the future enhanced fourth generation (4G) and fifth generation (5G) wireless mobile communication systems, in order to meet the above development needs, various corresponding key technologies have begun to be presented and demonstrated and are worthy of extensive attention of researchers in the field.

In October 2007, the International Telecommunication Union (ITU) approved the Worldwide Interoperability for Microwave Access (WiMax) to become the fourth 3G system standard. This event which occurred at the end of the 3G era is, in fact, a rehearsal of the scramble for 4G standard. As the matter of fact, in order to meet the challenges of wireless IP technology flow represented by wireless LAN and WiMax, since 2005 the 3GPP organization has been doing a total system upgrade, i.e., standardization of long-term evolution system (LTE). This is a quasi-fourth-generation system based on. Orthogonal Frequency Division Multiplexing (OFDM), which was first released in early 2009 and has been commercially available in succession in 2010. At the same time, the standardization work of the 3GPP organization on the fourth generation (4G) wireless mobile communication system, known as the Long Term Evolution Advanced (LTE-A) System, has also been initiated in the first half of 2008. The key standardization document of the physical layer process of the system was completed in early 2011. In November 2011, the ITU organization officially announced in Chongqing, China, that the LTE-A system and the WiMax system are two official standards for the 4G system. At present, the commercialization of the LTE -A system is being carried out worldwide.

In order to meet the challenges of the next decade, for the enhanced fourth-generation wireless mobile communication system, there are generally the following development demands
higher wireless broadband rate with the focus on optimizing the local cell hotspot area;
further enhancing the user experience, particularly optimizing communication services in the boundary area of cells;
in consideration that the available spectrum cannot have 1000 times expansion, the necessity to continue to study new technologies to improve the utilization efficiency of the spectrum;
high-band spectrum (5 GHz, or even higher) certainly being put into use to get a larger communication bandwidth;
existing networks (2G/3G/4G, WLAN, WiMax, etc.) working together to share data traffic;
specific optimization for different services, applications and services;
strengthening the system's ability to support large-scale machine communications;
flexible, intelligent and inexpensive network planning and network deployment;
providing a solution to save power consumption of networks and battery consumption of user equipment.

In traditional 3GPP LTE systems, data transmission can only be carried out over licensed bands/carriers. However, with the rapid increase in traffic, especially in hotspot areas of some cities, it may be difficult for licensed bands/carriers to meet the demand of increased traffic. A new research topic, i.e., the study on unlicensed bands carriers (RP-132085), was discussed at the 3GPP RAN #62 meeting, mainly focusing on the study of non-standalone deployment of LTE using an unlicensed spectrum; the so-called non-standalone means that the communication over an unlicensed spectrum is associated with a serving cell over a licensed spectrum. A direct approach is to continue to use the carrier aggregation (CA) manner in the LTE system as long as possible, that is deploy the licensed spectrum as the primary component carrier (PCC) of the serving base station and deploy the unlicensed spectrum as a secondary component carrier (SCC).

However, application of the traditional LTE system to the unlicensed spectrum will have the following problems.
The unlicensed spectrum may be used by networks corresponding to other access technologies, such as a Wi-Fi network. The LTE system needs to be capable of detecting the channel quality of the unlicensed spectrum before entering the unlicensed spectrum, so as to avoid interference with other access networks such as the Wi-Fi network. The measurement of the current LTE system cannot support such operations yet
The bandwidth of the unlicensed spectrum may be much larger than the maximum bandwidth (100 MHz) supported by the LTE system, while the network side needs to select and configure the user equipment for the unlicensed spectrum actually scheduled in a cross-carrier manner.

At present, for the unlicensed spectrum, there is a common working manner, i.e., the Listen Before Talk (LBT). For the LBT, Europe and Japan limit the Channel Occupancy Time Window (COTW) of the LBT, 13 ms at most in Europe, and less than 4 ms in Japan. Based on this fact, a complete HARQ process (such as one initial transmission plus three retransmissions) cannot be completed in one COTW. Because of the operational characteristics of the unlicensed spectrum system, after the initial transmission is completed, subsequent retransmissions cannot be guaranteed to be scheduled to the same unlicensed carrier. However, the current LTE HARQ protocol mainly deals with the transmission of data over the licensed spectrum, where the initial transmission and retransmissions of the data are always scheduled to the same carrier. Therefore, the present LTE HARQ protocol cannot maintain an HARQ process over different carriers, and thus is not adaptive to data retransmission over unlicensed carriers.

Accordingly, there is a need for a data retransmission method suitable for use in a communication system that supports an unlicensed carrier.

### SUMMARY OF THE INVENTION

In order to achieve the above objective, the present invention, based on LTE and LTE-A networks, provides a data retransmission method applied in a communication system supporting an unlicensed carrier, and a base station and user equipment executing the method. In the solution according to the present invention, an HARQ entity is configured to match multiple serving cells which respectively correspond to different carriers, so that the HARQ entity can maintain an HARQ process over different carriers.

According to a first aspect of the present invention, a data retransmission method applied in a communication system supporting an unlicensed carrier is provided. The method includes: sending configuration information indicating that an HARQ entity is matched with multiple serving cells to user equipment, where the number of serving cells matched with the HARQ entity is equal to or less than the number of serving cells configured for the user equipment by a serving base station; and based on the configuration of matching the HARQ entity with the multiple serving cells, executing initial transmission and retransmission of data.

In some embodiments of the present invention, the configuration information is carried by RRC signaling.

In some embodiments of the present invention, the serving cells matched with the HARQ entity include at least one serving cell corresponding to an unlicensed carrier.

In some embodiments of the present invention, the multiple serving cells in the configuration information may be indicated by any one of carrier frequency information, carrier identification information, and reference signal configuration information.

In some embodiments of the present invention, the method may further include: sending HARQ time window configuration information to the user equipment, where the HARQ time window configuration information indicates a duration of a continuous time window corresponding to the HARQ entity on an unlicensed carrier; and terminating the retransmission of data after the HARQ time window is exceeded.

In some embodiments of the present invention, the HARQ time window configuration information is carried by the RRC signaling.

According to a second aspect of the present invention, a data retransmission method applied in a communication system supporting an unlicensed carrier is provided. The method includes: receiving configuration information indicating that an HARQ entity is matched with multiple serving cells, where the number of serving cells matched with the HARQ entity is equal to or less than the number of serving cells configured for the user equipment by a serving base station; and based on the received configuration intimation, receiving initial transmission and retransmission of data.

According to a third aspect of the present invention, a base station is provided. The base station includes; a configuration in sending unit, configured to send configuration information indicating that an HARQ entity is matched with multiple serving cells to the user equipment, where the number of serving cells matched with the HARQ entity is equal to or less than the number of serving cells configured for user equipment by a serving base station; and a data transmitting unit, configured to, based on the configuration of matching the HARQ entity with the multiple serving cells, execute initial transmission and retransmission of data.

According to a fourth aspect of the present invention, user equipment is provided. The user equipment includes: a configuration information receiving unit, configured to receive configuration information indicating that an HARQ entity is matched with multiple serving cells, where the number of serving cells matched with the HARQ entity is equal to or less than the number of serving, cells configured for the user equipment by a serving base station; and a data receiving unit, configured to, based on the received configuration information, receive initial transmission and retransmission of data.

### BRIEF DESCRIPTION OF THE DRAWINGS

The above and other features of the present invention will be clearer from else detailed description made in connection with the accompanying drawings, in which:

FIG. 1 is a flow diagram of a method executed at a base station side according to the first embodiment of the present invention;

FIG. 2 is a flow diagram of a method executed at user equipment according to the first embodiment of the present invention;

FIG. 3 is a flow diagram of a method executed at a base station side according to the second embodiment of the present invention;

FIG. 4 is a flow diagram of a method executed at user equipment according to the second embodiment of the present invention;

FIG. 5 is a flow diagram of a method executed at a base station side according to the third embodiment of the present invention;

FIG. 6 is a flow diagram of a method executed at user equipment according to the third embodiment of the present invention;

FIG. 7 is a schematic block diagram of a base station according to embodiments of the present invention; and

FIG. 8 is a schematic block diagram of user equipment according to embodiments of the present invention.

Throughout the accompanying drawings of the present invention, identical or similar elements are all marked with identical or similar drawing references.

### DETAILED DESCRIPTION OF THE INVENTION

With reference to the accompanying drawings and preferred embodiments and based on. LTE and LTE-A networks, the data retransmission mechanism suitable for use in a communication system supporting an unlicensed carrier, provided by the present invention, is described hereinafter.

As mentioned above, the existing LTE HARQ is mainly adaptive to data communications only over a licensed carrier. In this case, retransmission of data is always scheduled to the carrier the same as the carrier over which the data is initially transmitted. In other words, the HARQ entity is bound to a single carrier. Therefore, the user equipment knows over which carrier to wait for receiving the retransmission of data.

However, the existing LTE HARQ mechanism will have problems when applied to a communication system supporting an unlicensed carrier. In the communication system supporting an unlicensed carrier, due to the operational characteristics of an unlicensed spectrum system (i.e., a limited channel occupancy time window), after the initial transmission is completed over an unlicensed carrier, subsequent retransmissions cannot be guaranteed to be scheduled to the same unlicensed carrier. The present LTE HARQ protocol cannot deal with this situation because it cannot maintain an. HARQ process over different carriers.

In order to solve the above problem, the present invention provides a solution that the HARQ entity is configured to match multiple carriers supported by the user equipment so that the HARQ entity can maintain a cross-carrier HARQ process. The base station may, through signaling, inform the user equipment such configuration that the HARQ entity is matched with the multiple carriers. Therefore, the base station may perform initial transmission and retransmission of data based on such configuration. The user equipment may also perform reception and corresponding demodulation and subsequent operations on the initial transmission and retransmission of data.

As used in this disclosure, the term “HARQ entity” refers to a logic entity responsible for HARQ retransmission of data (e.g., PDU at an MAC layer) between the base station and the user equipment. The HARQ entity may be specifically implemented as an MAC layer function on the base station or user equipment.

It is to be noted that the present invention shall not be limited to the embodiments described below. In addition, for the sake of brevity, details on the well-known technology that is not directly related to the present invention are omitted in the following description to prevent confusion in the present invention.

Taking the LTE mobile communication system and its subsequent evolved version as examples of application environments of the present invention, various embodiments of the present invention are described below in detail. It is to be noted, however, that the present invention is not limited to the following embodiments and is applicable to any communication system that supports an unlicensed carrier, such as a future 5G cellular communication system.

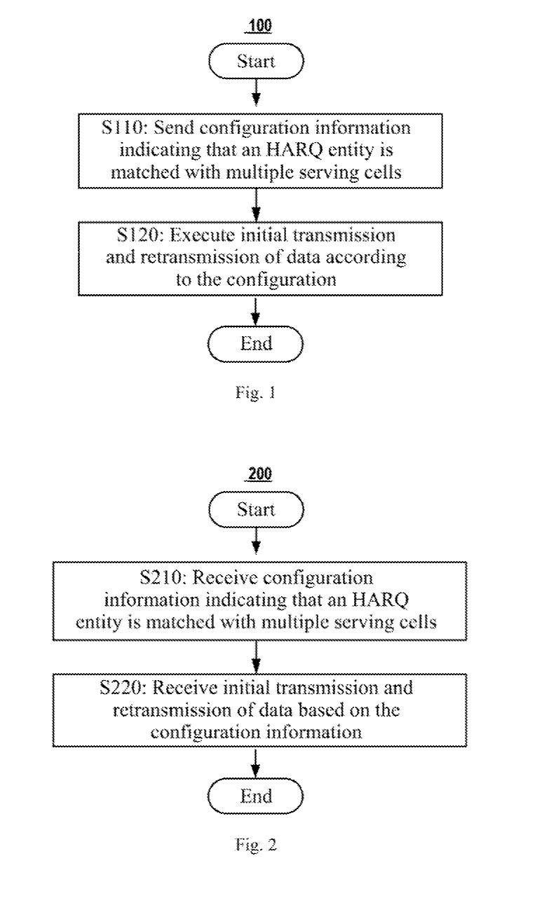

A first embodiment of the present invention is described below with reference to FIG. 1 and FIG. 2.

FIG. 1 schematically illustrates a flow diagram of a data retransmission method 100 applied in a communication system supporting an unlicensed carrier according to the first embodiment of the present invention in the view of a base station.

In step S110, a base station transmits configuration information indicating that an HARQ entity is matched with multiple serving cells to user equipment. In a communication system supporting an unlicensed carrier, a serving base station may configure more than one serving cell for the user equipment. Different serving cells correspond to different carriers. These carriers may be licensed carriers or unlicensed carriers. The number of serving cells matched with the same HARQ entity is equal to or less than the number of serving cells configured for the user equipment by the serving base station. Preferably, the serving cells matched with the HARQ entity include at least one serving cell corresponding to an unlicensed carrier.

In an exemplary implementation, the configuration in information indicating that an HARQ entity is matched with multiple serving cells may be carried by RRC signaling.

In the configuration information indicating that an HARQ entity is matched with multiple serving cells, the multiple serving cells may be indicated in many ways.

As an indicating way, the multiple serving cells may be indicated by corresponding carrier frequency information. For example, the carrier frequency information may be similar to frequency band indication corresponding to d1-CarrierFreq in TS 36.331. Definite carrier frequency information corresponding to the band indication may be obtained from, for example, an E-UTRA Operating Band in Table 5.7.3-1 in TS 36.101. It should be understood that all tables here similar to Table 5.7.3-1 are tables of new available bands pre-defined for the LTE-U in the 5 GHz band, as shown in Table 1.

TABLE 1

| E-UTRA Unlicensed Operating Band | Range(MHz) |
|---|---|
| 1 | 5170-5190 |
| 2 | 5190-5210 |
| 3 | 5210-5230 |
| 4 | 5230-5250 |
| 5 | 5250-5170 |
| 6 | 5270-5290 |
| 7 | 5290-5310 |
| 8 | 5310-5330 |
| 9 | 5490-5510 |
| 10 | 5510-5530 |
| 11 | 5530-5550 |
| 12 | 5550-5570 |
| 13 | 5570-5590 |
| 14 | 5590-5610 |
| 15 | 5610-5630 |
| 16 | 5630-5650 |
| 17 | 5650-5670 |
| 18 | 5670-5690 |
| 19 | 5690-5710 |
| 20 | 5710-5730 |
| 21 | 5735-5755 |
| 22 | 5755-5775 |
| 23 | 5775-5795 |
| 24 | 5795-5815 |
| 25 | 5815-5835 |

For another example, the frequency information may be a start frequency (e.g., 5170 MHz) of a band corresponding to the unlicensed spectrum.

As another indicating way, the multiple serving cells may be indicated by corresponding physical cell identification information. The physical cell identification information may be identification information used for indicating a physical cell reserved for an unlicensed spectrum, such as physCellId in TS 36.331, which may have a value of 0-503.

As yet another indicating way, the multiple serving cells may be indicated by corresponding carrier identification information. The carrier identification information is used for indicating the position serial number of a specific unlicensed carrier in a whole unlicensed spectrum. For example, it may be the serial number of the E-UTRA Unlicensed Operating Band in Table 1. For another example, if the carrier frequency information is indicated by a band range or a spectrum start frequency, the identification information may be the series number of a specific unlicensed carrier in the whole configured licensed spectrum. Specifically, the serial number may be indicated explicitly or implicitly. For example, the serial number may be determined by the user equipment based on the position of the configuration information in the whole configuration information set.

As another indicating way, the serving cells may be indicated by corresponding reference signal configuration information. The reference signal configuration information is configuration information used for indicating a discovery reference signal (U-DRS) transmitted over a specific unlicensed spectrum and designed for the unlicensed spectrum. For example, the reference signal configuration information may be configured with reference to the configuration manner of discovery reference signaling in the current LTE while having a sparser period. For example, a U-DRS may be transmitted by a subframe every 20 ms/40 ms/50 ms/100 ms/200 ms,

in step S120 the base station execute initial transmission and retransmission of data based on the configuration of matching the HARQ entity with the multiple serving cells. Specifically, the multiple serving cells for the data transmission (initial transmission and retransmission) are all controlled by the same HARQ entity and therefore share the HARQ entity, Data transmission corresponding to the same MAC PDU, i.e. initial transmission and retransmission, may be switched between the multiple serving cells. The specific serving cell for the transmission may be indicated by DCI in PDCCH or EPDCCH transmitted by the base station.

FIG. 2 schematically illustrates a flow diagram of a data retransmission method 200 applied in a communication system supporting an unlicensed carrier according to the first embodiment of the present invention in the view of user equipment.

In step S210, the user equipment receives configuration information indicating that an HARQ emit is matched with multiple serving cells from the base station. The number of serving cells indicated to be matched with the same HARQ entity in the configuration information is equal to or less than the number of serving cells configured for the user equipment by the base station.

In step S220, the user equipment receives the initial transmission and corresponding retransmission of data based on the received configuration information of matching the HARQ entity with the serving cells. Then, combination, demodulation and subsequent operations may be performed on the received initial transmission and possible retransmission of data. For example, in the case that data transmissions on the serving cells meeting the matching configuration belong to the same HARQ entity, the redundancy version (RV) based combination and demodulation is performed on the data of the initial transmission and the corresponding retransmission.

It is understood easily that the above-mentioned methods 100 and 200 may be executed cooperatively to complete data transmission between the base station and the user equipment in the communication system supporting an unlicensed carrier.

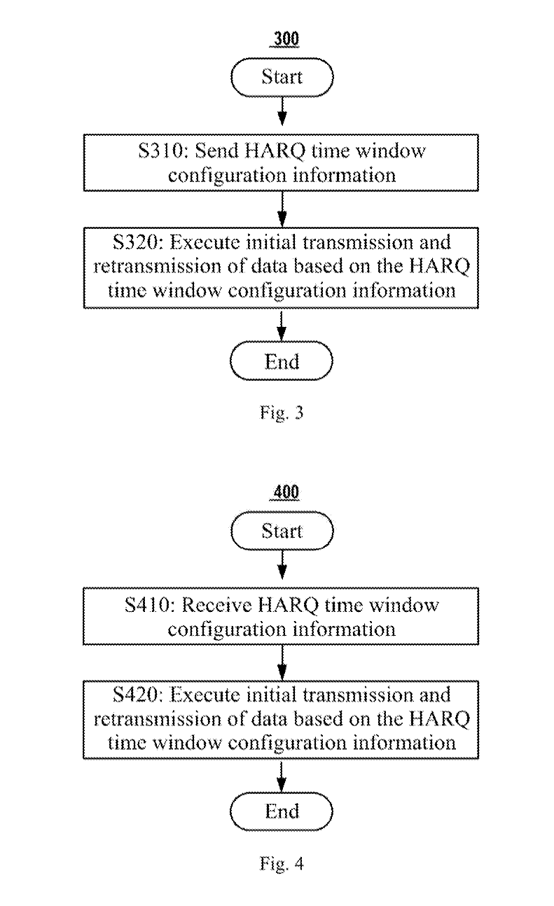

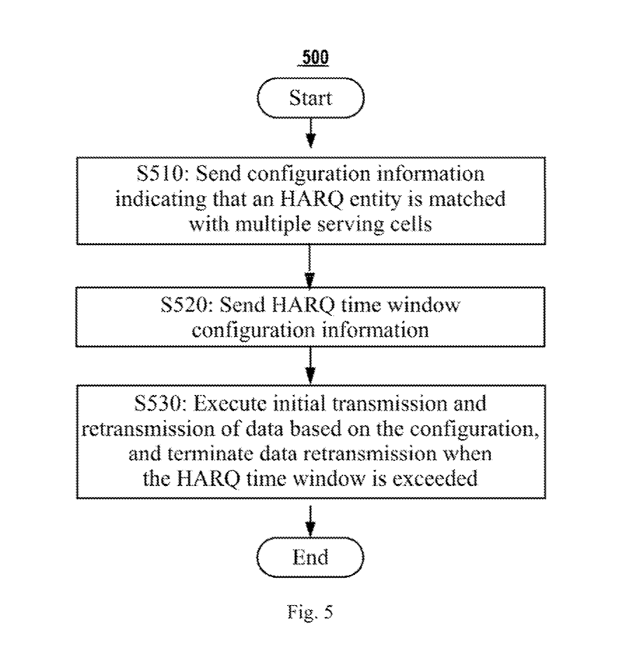

A second embodiment of the present invention is described below with reference to FIG. 3 and FIG. 4. In the second embodiment, as described in the present invention, in consideration of the limited channel occupancy time window on the unlicensed carrier, an HARQ time window for the unlicensed carrier may be set so that the retransmission of data is stopped when the HARQ time window is exceeded, thus relieving the HARQ retransmission problem caused by the introduction of the unlicensed carrier.

FIG. 3 schematically illustrates a flow diagram of a data retransmission method 300 applied in a communication system supporting an unlicensed carrier according to the second embodiment of the present invention in the view of a base station.

In step S310, the base station transmits HARQ time window configuration information to the user equipment, where the HARQ time window configuration information indicates a duration of a continuous time window corresponding to the HARQ entity on an unlicensed carrier. For example, the time window may represent the maximum duration of initial transmission and retransmission corresponding, to the same MAC PDU, and may generally have a default unit of millisecond tins). If the value of the configuration information is 20, it means that the maximum duration of initial transmission and retransmission corresponding to the same MAC PDU is 20 ms,

In an exemplary implementation, the HARQ time window configuration information may be carried by RRC signaling.

In step S320, the base station performs the initial transmission and corresponding retransmission of data based on the HARQ time window configuration information. The base station terminates the retransmission of data after the HARQ time window is exceeded. Referring to the above example, if the value of the configuration information is 20, it means that the maximum duration of initial transmission and retransmission corresponding to the same MAC PDU is 20 ms. In the case of this configuration, if ACK data is still not received after 20 ms, retransmission will not be arranged in the view of the base station. Therefore, corresponding buffer at the base station may be emptied and a new transmission is performed for the MAC PDU,

FIG. 4 schematically illustrates a flow diagram of a data retransmission method 400 applied in a communication system supporting an unlicensed carrier according to the second embodiment of the present invention in the view of user equipment.

In step S410, the user equipment receives HARQ time window configuration information from the base station. The HARQ time window configuration information indicates a duration of a continuous time window corresponding to the HARQ entity on an unlicensed carrier. For example, the time window may represent the maximum duration of initial transmission and retransmission corresponding to the same MAC PDU and may generally have a default unit of millisecond (ms). If the value of the configuration information is 20, it means that the maximum duration of initial transmission and retransmission corresponding to the same MAC PDU is 20 ms.

In step S420, the user equipment receives the initial transmission and corresponding retransmission of data based on the HARQ time window configuration information. The waiting for receiving retransmission of data may be terminated when the HARQ time window is exceeded. For example, if the configuration information of the HARQ time window is 20, it means that the maximum duration of initial transmission and retransmission corresponding to the same MAC PDU is 20 ms. If the data is still not received correctly after 20 ms, in the view of the user equipment, corresponding buffer at the user equipment is emptied and the subsequent receipt of the MAC PDU is regarded as new data if any.

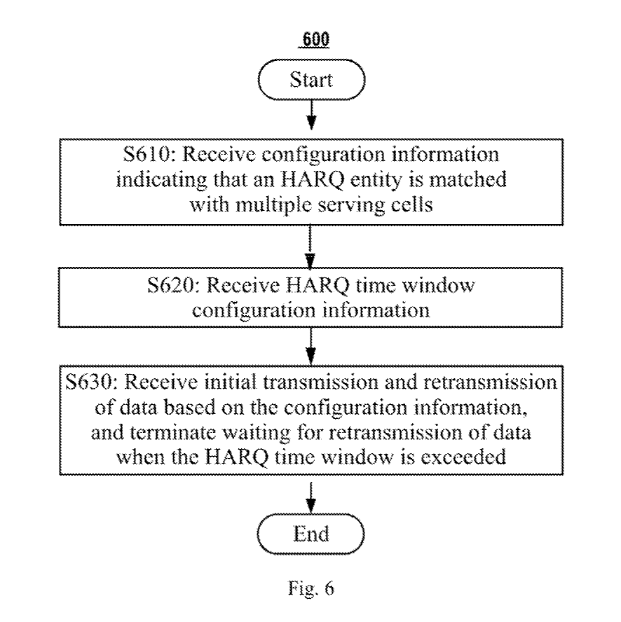

The third embodiment of the present invention is described below with reference to FIG. 5 and FIG. 6. In the third embodiment of the present invention, not only is the HARQ entity configured to be matched with multiple carriers supported by the user equipment, but the HARQ time window on an unlicensed carrier is also configured.

FIG. 5 schematically illustrates a flow diagram of a data retransmission method 500 applied in a communication system supporting an unlicensed carrier according to the third embodiment of the present invention in the view of a base station.

In step S510, a base station transmits configuration information indicating that an HARQ entity is matched with multiple serving cells to user equipment. As described above, in a communication system supporting data transmission over an unlicensed carrier, the serving base station may configure more than one serving cells for the user equipment. Different serving cells correspond to different carriers. These carriers may be licensed carriers or unlicensed carriers. The number of serving cells matched with the same HARQ entity is equal to or less than the number of serving cells configured for the user equipment by the serving base station.

Preferably, the serving cells matched with the HARQ entity include at least one serving cell corresponding to an unlicensed carrier.

Optionally, the configuration information may be carried by RRC signaling.

Optionally, the multiple serving cells in the configuration information may be indicated by any one of carrier frequency information, carrier identification information, and reference signal configuration information.

In step S520, the base station transmits HARQ time window configuration information to the user equipment, where the HARQ time window configuration information indicates a duration of a continuous time window corresponding to the HARQ entity on an unlicensed carrier.

In step S530, the base station performs initial transmission and corresponding retransmission of data based on the configuration of matching the HARQ entity with the multiple serving cells and the configured HARQ time window. In addition, the base station terminates the retransmission of data after the HARQ time window is exceeded.

Specifically, data transmission corresponding to the same MAC PDU (i.e., initial transmission and possible retransmission) may be executed within the configured HARQ time window (e.g.., 20 ms as mentioned above) and may be switched between the serving cells matched with the HARQ. If ACK data is still not received when the HARQ time window is exceeded, the base station will not arrange retransmission. Therefore, corresponding buffer at the base station may be emptied and a new transmission is performed for the MAC PDU.

FIG. 6 schematically illustrates a flow diagram of a data retransmission method 600 applied in a communication system supporting data transmission over an unlicensed carrier according to the third embodiment of the present invention in the view of user equipment.

In step S610, the user equipment receives configuration information indicating, that an HARQ entity is matched with multiple serving cells from the base station. The number of serving cells indicated to be matched with the same HARQ entity in the configuration information is equal to or less than the number of serving cells configured for the user equipment by the base station.

In step S620, the user equipment receives HARQ time window configuration information from the base station. The HARQ time window configuration information indicates a duration of a continuous time window corresponding to the HARQ entity on an unlicensed carrier.

In step S630, the user equipment receives the initial transmission and corresponding retransmission of data based on the received configuration information of matching the HARQ entity with the multiple serving cells and the HARQ time window configuration information. In addition, the user equipment terminates the receipt of data retransmission after the HARQ time window is exceeded.

Specifically, data transmission corresponding to the same MAC PDU (i.e., initial transmission and possible retransmission) may be executed within the configured HARQ time window (e.g., 20 ms as mentioned above) and may be switched between the serving cells matched with the HARQ. The user equipment may receive the initial transmission and retransmission for the MAC PDU within the HARQ time window and perform combination and demodulation, as well as subsequent operations on the received data. If the ACK data is still not received when the HARQ time window is exceeded, the user equipment stops waiting, and empty corresponding butler at the user equipment. In addition, the subsequent receipt of the MAC PDU is regarded as new data if any.

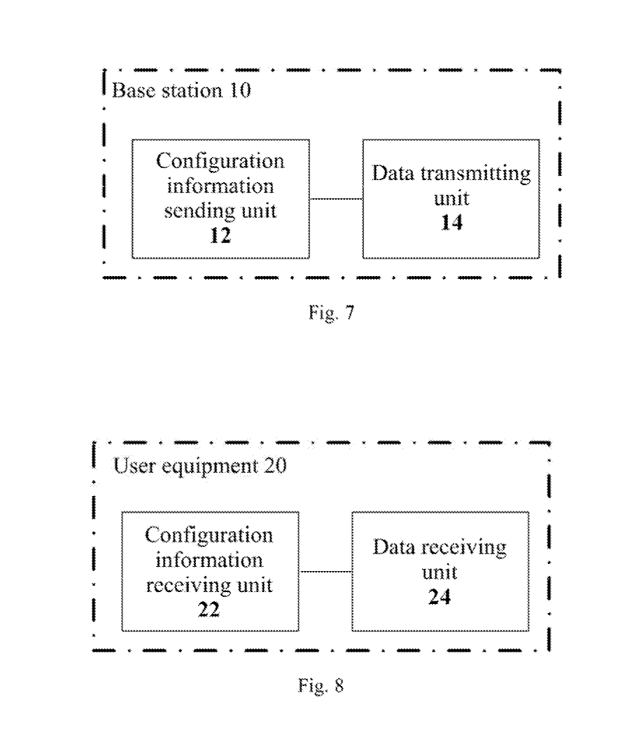

FIG. 7 is a schematic block diagram of a base station suitable for use in a communication system supporting an unlicensed carrier according to embodiments of the present invention. As illustrated by the figure, the base station 10 may include a configuration information sending unit 12 and a data transmitting unit 14.

The configuration information sending unit 12 may be configured to send configuration information indicating that an HARQ entity is matched with multiple serving cells to user equipment. The number of serving cells matched with the HARQ entity is equal to or less than the number of serving cells configured for the user equipment by the serving base station.

As described above, preferably, the serving cells matched with the HARQ entity include at least one serving cell corresponding to an unlicensed carrier. The configuration information indicating that an HARQ entity is matched with multiple serving cells may be carried by RRC signaling. The multiple serving cells in the configuration information may be indicated by any one of carrier frequency information, carrier identification information and reference signal configuration information.

The data transmitting unit 14 may be configured, to execute initial transmission and, retransmission of data based on the configuration information of matching the HARQ entity with the multiple serving cells.

Preferably, the configuration information sending unit 12 may further be configured to send HARQ time window configuration information to the user equipment. The HARQ time window configuration information indicates a duration of a continuous time window corresponding to the HARQ entity on an unlicensed carrier. The HARQ time window configuration information may be carried by RRC signaling. The data transmitting unit 14 may further be configured to terminate the retransmission of data after the HARQ time window is exceeded.

FIG. 8 is a schematic block diagram of user equipment suitable for use in a communication system supporting an unlicensed carrier according to embodiments of the present invention. As illustrated by the figure, the user equipment 20 may include a configuration information receiving unit 22 and a data receiving unit 24.

The configuration information receiving unit 22 may be configured to receive configuration information indicating that an HARQ entity is matched with multiple serving, cells, where the number of serving cells matched with the HARQ entity is equal to or less than the number of serving cells configured for the user equipment by the serving base station.

The data receiving unit 24 may be configured to, based on the received configuration information, receive initial transmission and retransmission of data.

As described above, preferably, the serving cells matched with the HARQ entity include at least one serving cell corresponding to an unlicensed carrier. The configuration information indicating that an HARQ entity is matched with multiple serving cells may be carried by RRC signaling. The multiple serving cells in the configuration information may be indicated by any one of carrier frequency information, carrier identification information, and reference signal configuration information,

Preferably, the configuration information receiving unit 22 may further be configured to receive HARQ time window configuration information, where the HARQ time window configuration information indicates a duration of a continuous time window corresponding to the HARQ entity on an unlicensed carrier. The HARQ time window configuration information may be carried by RRC signaling. The data receiving unit 24 may further be configured to terminate waiting for retransmission of data after the HARQ time window is exceeded.

The base station 10 according to the embodiments of the present invention may be configured to execute the above method 100, 300 or 500. The user equipment 20 according to the embodiments of the present invention may be configured to execute the above method 200, 400 or 600. Their operations will not be repeated here.

The present intention has been described above in conjunction with preferred embodiments. It should be understood by a person skilled in the art that the methods and equipment illustrated above are only exemplary. The method of the present invention is not limited to steps or sequences illustrated above. For example, the method of the present invention may include more optional steps. Equipment of the present invention is likewise not limited to the illustrated components. For example, the equipment of the present invention may include more components than the illustrated components. A person skilled in the art would be taught by the illustrated embodiments to make many alterations and modifications.

It should be understood that the above embodiments of the present invention may be implemented through software, hardware or combination of software and hardware. For example, various components in the base station and the user equipment in the above embodiments may be implemented through various devices, including but not limited to an analog circuit device, a digital circuit device, a digital signal processing (DSP) circuit, a programmable processor, an application specific integrated circuit (ASIC), a field programmable gate array (FPGA), a programmable logic devices (CPLD), and the like.

In this disclosure, the “base station” refers to a mobile communication data and control switching center with large transmission power and wide coverage area, having functions of resource allocation scheduling, data receiving and transmitting, and the like. The “user equipment” refers to a user mobile terminal, such as a mobile phone, a notebook, or other terminal device that can perform wireless communication with a base station or a micro base station.

In addition, the disclosed embodiments of the present invention may be implemented on a computer program product. More specifically, the computer program product is a product described as below. The product has a computer-readable medium on which a computer program logic is encoded. The computer program logic provides relevant operations to implement the above-described technical solution of the present invention when the product is executed on a computing device. The computer program logic enables a processor to execute the operations (methods) described in the embodiments of the present invention when the product is executed on at least one processor of a computing system. Such an arrangement of the present invention is typically provided as software a code, and/or other data structures that are configured or encoded on a computer-readable medium, such as a optical medium (e.g., a CD-ROM), a floppy disk or a hard dish:, or, for example, firmware or other media of microcodes on one or more ROM or RAM or PROM chips, or downloadable software images, shared database and so on in one or more modules. Software or firmware or such configuration may be installed on a computing device such that one or more processors in the computing device perform the technical solutions described in the embodiments of the present invention.

Although the present invention has been shown in connection with the preferred embodiments of the present invention, it is understood by those skilled in the art that various modifications, substitutions and alterations may be made to the present invention without departing from the spirit and scope of the present invention. Accordingly, the present invention should not be defined by the above-described embodiments, but should be defined by the appended claims and their equivalents.

1. A data retransmission method applied in a communication system supporting an unlicensed carrier, comprising:
sending configuration information indicating that an HARQ entity is matched with a plurality of serving cells to user equipment, wherein the number of serving cells matched with the HARQ entity is equal to or less than the number of serving cells configured for the user equipment by a serving base station; and
based on the configuration of matching the HARQ entity with the plurality of serving cells, executing initial transmission and retransmission of data.

2. The method according to claim 1, wherein the configuration information is carried by RRC signaling..

3. The method according to claim 1, wherein the serving cells matched with the HARQ entity comprise at least one serving cell corresponding to an unlicensed carrier.

4. The method according to claim 1, wherein the plurality of serving cells in the configuration information are indicated by any one of carrier frequency information, carrier identification information, and reference signal configuration information.

5-6. (canceled)

7. A data retransmission method applied in a communication system supporting an unlicensed carrier, comprising:
receiving configuration information indicating that an HARQ entity is matched with a plurality of serving cells, wherein the number of serving cells matched with the HARQ entity is equal to or less than the number of serving cells configured for user equipment by a serving base station; and
based on the received configuration information, receiving initial transmission and retransmission of data.

8. The method according to claim 7, wherein the configuration information is carried by RRC signaling.

9. The method according to claim 7, wherein the serving cells matched with the HARQ entity comprise at least one serving cell corresponding to an unlicensed carrier.

10. The method according to claim 7, wherein the plurality of serving cells in the configuration information are indicated by any one of carrier frequency information, carrier identification information, and reference signal configuration information.

11.-12. (canceled)

13. A base station, comprising:
a configuration information sending unit, configured to send configuration information indicating that an HARQ entity is matched with a plurality of serving cells to the user equipment, wherein the number of serving cells matched with the HARQ entity is equal to or less than the number of serving cells configured for user equipment by a serving base station; and
a data transmitting unit, configured to execute initial transmission and retransmission of data based on the configuration of matching the HARQ entity with the plurality of serving cells.

14. The base station according to claim 13, wherein the configuration information is carried by RRC signaling.

15. The base station according to claim 13, wherein the serving cells matched with the HARQ entity comprise at least one serving cell corresponding to an unlicensed carrier.

16. The base station according to claim 13, wherein the plurality of serving cells in the configuration information are indicated by any one of carrier frequency information, carrier identification information, and reference signal configuration information.

17. The base station according to claim 13, wherein,
the configuration information sending unit is further configured to send HARQ time window configuration information to the user equipment, wherein the HARQ time window configuration information indicates a duration of a continuous time window corresponding to the HARQ entity on an unlicensed carrier; and
the data transmitting unit is further configured to terminate the retransmission of data after an HARQ) time window is exceeded.

18. The base station according to claim 17, wherein the HARQ time window configuration information is carried by RRC signaling.

19. User equipment, comprising:
a configuration information receiving unit, configured to receive configuration information indicating that an HARQ entity is matched with a plurality of serving cells, wherein the number of serving cells matched with the HARQ entity is equal to or less than the number of serving cells configured for the user equipment by a serving base station; and
a data receiving unit, configured to, based on the received configuration information, receive initial transmission and retransmission of data.

20. The user equipment according to claim 19, wherein the configuration information is carried by RRC signaling.

21. The user equipment according to claim 19, wherein the serving cells matched with the HARQ entity comprise at least one serving cell corresponding to an unlicensed carrier.

22. The user equipment according to claim 19, wherein the plurality of serving cells in the configuration information are indicated by any one of carrier frequency information, carrier identification information, and reference signal configuration information.

23. The user equipment according to claim 19, wherein:
the configuration information receiving unit is further configured to receive HARQ time window configuration information, wherein the HARQ time window configuration information indicates a duration of a continuous time window corresponding to the HARQ entity on an unlicensed carrier; and
the data receiving unit is further configured to terminate waiting for the retransmission of data after an HARQ time window is exceeded.

24. The user equipment according to claim 23, wherein the HARQ time window configuration information is carried by RRC signaling.
